(19) United States
(12) Patent Application Publication
(10) Pub. No.: US 2012/0301375 A1
(43) Pub. Date: Nov. 29, 2012

(54) LOW ENERGY METHOD OF PREPARING BASIC METAL CARBONATES AND OTHER SALTS

(76) Inventors: Jeff Miller, Hancock, MI (US); Brian Miller, Lake Linden, MI (US); Andrew Bourdeau, Houghton, MI (US)

(21) Appl. No.: 13/117,279

(22) Filed: May 27, 2011

(51) Int. Cl. C01G 9/00; C01D 15/08; C01D 7/00; C01G 5/00; C01G 51/06; C01G 45/00; C01G 19/00; C01G 21/14; C01G 53/06

(52) U.S. Cl. 423/42; 423/50; 423/92; 423/105; 423/144; 423/179.5; 423/187; 423/419.1; 423/421; 423/433

(57) ABSTRACT

A method of preparing basic metal carbonate selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising: contacting the metal with an aqueous solution comprising an amine, carbonic acid, and oxygen under conditions where the metal is converted into basic metal carbonate; and recovering the basic metal carbonate.

### BACKGROUND OF THE INVENTION

Basic metal carbonates (BMC) are well-known chemical compounds which have a variety of uses including, without limitation, in pigments, chemical manufacturing, petroleum refining, electronics, and pharmaceuticals. Generally, BMC may be represented by the following formulae: (M₂CO₃)ₓ(MOH)_{y}, (MCO₃)ₓ(M(OH)₂)_{y}, (M₂(CO₃)₃)ₓ(M(OH)₃)_{y}, or (M(CO₃)₂)ₓ(M(OH)₄)_{y}, wherein x>0 and y>0, and wherein the valency of the metal ion is 1, 2, 3, or 4, respectively. Examples of BMC formulae for specific metals include: zinc, (ZnCO₃)ₓ(Zn(OH)₂)_{y}; nickel, (NiCO₃)ₓ(Ni(OH)₂)_{y}; and silver, (Ag₂CO₃)ₓ(AgOH)_{y}.

Methods for the preparation of a variety of BMC are known in the art. U.S. Pat. No. 6,555,075 describes a method in which basic zinc carbonate (BZC) is formed from an aqueous solution of zinc ash and urea. This process requires multiple steps of dissolution and precipitation and substantial energy input to drive off impurities and improve yields. U.S. Pat. No. 5,281,494 discloses a method of producing nickel hydroxide/basic nickel carbonate of varying CO₃ content from aqueous solutions of nickel powder, oxygen and ammonia by using carbonate ion as catalyst. This process also requires elevated temperatures. Another general method for preparing BMC is by electrolytic oxidation of metal in aqueous solution of carbonate, such as the process disclosed in U.S. Pat. No. 6,183,621 for producing basic cobalt carbonate.

A method for preparing BMC which provides advantages over known methods would be desirable. The biggest advantage of the present method is that the energy required to make these salts is much less than in other methods. We have shown that the present method works with zinc, nickel, silver, and cobalt as the metal cation component. The method should work as well for other metals, including tin, lead, manganese, and others. It is also within normal reason to expect that the carbonate anion could be replaced with other anions, including nitrates, sulfates, and phosphates.

### BRIEF SUMMARY OF THE INVENTION

The present invention meets the foregoing and other needs by providing, in one aspect, a method of preparing BMC selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising: contacting the metal with an aqueous solution comprising: an amine; carbonic acid; and oxygen, under conditions where the metal is converted into basic metal carbonate; and recovering the basic metal carbonate, wherein the metal is selected from the group consisting of zinc, nickel, silver, cobalt, tin, lead, manganese, lithium, sodium, and potassium.

A further aspect of the invention provides, a continuous method of preparing basic metal carbonates selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising: (a) providing an aqueous solution of ionized metal, the aqueous solution comprising an ionized metal, an amine, carbonic acid, and water in a reaction vessel; (b) adjusting the pH of the solution until basic metal carbonate is formed; (c) recovering the basic metal carbonate from the aqueous solution by subjecting the aqueous solution to filtration; (d) transferring the aqueous solution which remains after the recovery of basic metal carbonate in step (c) into a second vessel; (e) removing carbon dioxide from the aqueous solution which remains after the recovery of basic metal carbonate in step (c); (f) introducing a metal-containing material into the aqueous solution which remains after the removal of carbon dioxide in step (e); (g) oxidizing the metal-containing material to provide a replenished ionized metal solution; and (h) introducing the replenished ionized metal solution into the reaction vessel, wherein the metal is selected from the group consisting of zinc, nickel, silver, cobalt, tin, lead, manganese, lithium, sodium and potassium.

### BRIEF DESCRIPTION OF THE DRAWING

FIG. 1 is a schematic diagram showing an exemplary operational flow of a continuous method of preparing a basic metal carbonate according to one aspect of the present invention.

### DETAILED DESCRIPTION OF THE INVENTION

The various aspects of the present invention provide methods for preparing BMC.

In one aspect, the invention provides a method of preparing BMC selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising: providing a solution of metal in a reaction vessel, the solution comprising metal, an amine, carbonic acid, oxygen and water, adjusting the pH of the solution until BMC is provided; and recovering the BMC, wherein the metal is selected from the group consisting of zinc, nickel, silver, cobalt, tin, lead, manganese, lithium, sodium, and potassium.

The foregoing method may be practiced in any suitable reaction vessel, e.g., a spray chamber, a stirred tank reactor, a rotating tube reactor, or a pipeline reactor, in either a continuous or batch process. It is desirable to practice the method as a continuous process, more desirably using a continuous stirred tank reactor.

The particle size of BMC may be controlled by varying the concentrations of metal and ammonia in the solution, as well as by regulating the input rate of metal solution and/or CO₂ into the reaction vessel, and/or the endpoint of the precipitation reaction. The particle size may also be controlled by other process parameters, such as residence time or temperature.

In the solution provided in the reaction vessel, or feed solution, the metal included therein may originate from any suitable source. In addition to #1 metals (99% metal of interest) which may include metal tubing, powders, flakes, shavings, wires, and the like, suitable metal-containing material may be metal-containing plastics, alloys, clads, or compounds.

In practice, a typical metal-containing feed stream contains ammonia, water, carbonic acid, oxygen, and other components. A typical feed stream will include components, in certain amounts, as follows: metal, from about 10 g/L to about 160 g/L, desirably from about 20 g/L to about 85 g/L; water; oxygen; ammonia, from about 3 g/L to about 110 g/L, desirably from about 50 g/L to about 90 g/L, and ammonia to metal molar ratio from about 0.5:1 to about 8:1, desirably from about 1.5:1 to about 7:1, depending on the metal involved; and carbonic acid from about 15 g/L to about 130 g/L, desirably from about 70 g/L to about 110 g/L.

Generally, as the content of the feed stream is known, one skilled in the art should be able to create the feed stream with the amount of each component needed to be present in the reaction vessel to practice the inventive methods.

In the aspect of the invention that involves introducing a metal-containing material into a metal-depleted solvent system to provide an enriched metal solution, an additional amount of an amine may be added to assist in solubilizing the metal in the aqueous medium. The amine is desirably ammonia (which exists in the aqueous medium in equilibrium with ammonium hydroxide). The amount required to effect this dissolution will vary, but will generally range from about 0.5:1 to about 8:1, and desirably from about 1.5:1 to about 7:1, moles of amine to moles of metal. On an absolute basis, the amount of amine in the aqueous solution is desirably limited, ranging from about 3 g/L to about 110 g/L, and more desirably from about 50 g/L to about 90 g/L, of NH₃. In general, as the pressure in the reactor vessel increases, the allowable amine concentration may be increased.

The carbonic acid may be provided in the reaction vessel by any suitable means, but is preferably provided by introducing CO₂ into the reaction vessel, e.g., by bubbling CO₂ through the aqueous solution, or by providing a relative increase in the partial pressure of CO₂ within the reaction vessel. As used herein, the term carbonic acid includes carbonic acid as well as bicarbonate and carbonate ions, as it will be appreciated by one of ordinary skill in reading this disclosure that all of these species may be present when CO₂ is introduced into the aqueous solution.

Following precipitation and separation of the solids, it may be necessary to reduce the carbonate level, or increase the pH, in the solution to provide a suitable solution for metal leaching. This can be accomplished by reducing the partial pressure of CO₂ in the vessel, or nominally through a reduction of the total pressure within the reaction vessel.

The relationship between the components in the system, while not being bound by theory, may be simplistically explained in terms of an equation: [M^{x+}]ⁿ[OH⁻]^{m}[CO₃²⁻]^{p}=Kₛₚ, wherein x, n, m, and p are greater than 0, and Kₛₚ is a solubility product for BMC. When the products of certain ionic concentrations exceed the solubility constant for BMC (i.e., Kₛₚ), BMC will precipitate out of the solution. Not shown in the Kₛₚ equation is the solvating ligand ammonia that influences the concentration of metal ions available for bonding.

In the inventive methods, selectively increasing the concentration of one or more of metal ions, hydroxide ions or carbonate ions, or decreasing the ammonia concentration may be sufficient to cause BMC to precipitate from the solution.

For this invention addition of the CO₂ also adjusts the pH of the solution in order to precipitate BMC. In this regard, the pH of the solution is desirably relatively low, for example less than about 10, during the formation of BMC. More desirably, the pH may range from about 5.5 to about 10, preferably from about 6.5 to about 9, depending on the metal used. Preferably, the pH of the solution is adjusted by the introduction and removal of CO₂ from the reaction vessel.

One of the advantages of the inventive methods is that BMC may be obtained from metal-containing solutions using less energy relative to known methods. While the methods may be carried out at any suitable temperature, e.g., from about 5° C. to the boiling point of the solution, it is desirable that a limited amount or no heat need be added to the solution during the formation of the BMC. For example, the methods desirably contemplate maintaining the temperature of the solution from about 5° C. to about 100° C., more desirably from about 15° C. to about 80° C., and even more desirably from about 20° C. to about 60° C. Preferably, the temperature of the solution may range from about 25° C. to about 40° C.

The preparation of various metal carbonates optimally require different pH and chemical concentrations. For example, the most preferred pH range for zinc carbonate is 7.5 to 9, while for silver and nickel carbonate the most preferred pH range is 6.5-8.0. The most preferred molar ratio of amine to metal is about 5:1 to about 7:1 for zinc and nickel, while for silver, the most preferred ratio is about 1:1 to about 3:1.

While the preparation of BMC may be carried out while the reaction vessel is at ambient pressure, it may be desirable to increase the pressure in the reaction vessel in order to increase the yield per liter of feed solution. If desired, the pressure in the reaction vessel may desirably range from about 0 psig to about 1500 psig, more desirably range from about 20 psig to about 500 psig, and preferably range from about 80 psig to about 250 psig.

In another aspect, the inventive methods provide for a continuous method of preparing basic metal carbonates selected from the group consisting of zinc carbonate, nickel carbonate, silver carbonate, tin carbonate, lead carbonate, manganese carbonate. lithium carbonate, sodium carbonate, and potassium carbonate from metals comprising: (a) providing an aqueous solution of ionized metal, the aqueous solution comprising an ionized metal, an amine, carbonic acid, and water in a reaction vessel; (b) adjusting the pH of the solution until basic metal carbonate is formed; (c) recovering the basic metal carbonate from the aqueous solution by subjecting the aqueous solution to filtration; (d) transferring the aqueous solution which remains after the recovery of basic metal carbonate in step (c) into a second vessel; (e) removing carbon dioxide from the aqueous solution which remains after the recovery of basic metal carbonate in step (c); (f) introducing a metal-containing material into the aqueous solution which remains after the removal of carbon dioxide in step (e); (g) oxidizing the metal-containing material to provide a replenished ionized metal solution; and (h) introducing the replenished ionized metal solution into the reaction vessel.

The aforesaid metal solution includes a relatively low concentration of metal therein, as it is preferably the solvent system that remains after a metal solution having a relatively high metal concentration has been processed in accordance with the methods described herein to provide BMC. The depleted metal solution is replenished by the addition of raw material (metal), and the addition of ammonia, carbonic acid, water and oxygen, as needed. The ammonia, carbonic acid and water would be adjusted to the needed levels, and then the metal would be introduced to the solution. If needed, oxygen would be added during the metal/leach process.

In a related aspect, the inventive methods provide for the preparation of basic zinc carbonate (BZC) by the introduction of a zinc metal-containing material into a solution of ionized zinc, the solution comprising zinc, an amine, carbonic acid, and water. Illustrative of suitable zinc materials are zinc metal, bronze, zinc-containing plastics, alloys, compounds, and clads.

Desirably, and prior to introduction into the reaction vessel, the zinc metal-containing material is dissolved in a zinc-depleted solvent system comprising an amine to provide a solution which contains a relatively high concentration of zinc, which is preferably at least 15 g/L, more preferably at least 20 g/L, and most preferably at least 30 g/L zinc (II). Desirably, the ammonia concentration ranges from about 60 g/L to about 96 g/L, and the primary reaction vessel is at about 50 psig to about 300 psig, wherein this zinc-replenished solution is then introduced into the primary reaction vessel wherein BZC is formed.

Desirably, the methods of the invention contemplate that, in the reaction vessel, the molar ratio of ammonia to zinc ranges from about 3:1 to about 8:1; the pH of the solution in the reaction vessel ranges from about 7 to about 10; the temperature of the solution in the reaction vessel ranges from about 5° C. to about 80° C.; and the pressure in the reaction vessel ranges from about 0 psig to about 1500 psig. More desirably, in the reaction vessel, the molar ratio of ammonia to zinc in the solution ranges from about 4:1 to about 7:1; the pH of the solution in the reaction vessel ranges from about 7 to about 9; the temperature of the solution in the reaction vessel ranges from about 20° C. to about 60° C.; and the pressure in the reaction vessel ranges from about 20 psig to about 500 psig. Preferably, in the reaction vessel, the molar ratio of ammonia to zinc ranges from about 5:1 to about 7:1; the pH of the solution in the reaction vessel ranges from about 7.5 to about 9; the temperature of the solution in the reaction vessel ranges from about 25° C. to about 40° C.; and the pressure in the reaction vessel ranges from about 80 psig to about 250 psig.

In another aspect of the invention, the inventive methods provide for the preparation of BNC by the introduction of a nickel metal-containing material into a solution of nickel, the solution comprising nickel, an amine, carbonic acid, and water, wherein the solution comprises a molar ratio of ammonia to nickel ranging from about 5:1 to about 7:1, the pH of the solution in the reaction vessel ranges from about 6.5 to about 8.0, the temperature of the solution in the reaction vessel ranges from about 25° C. to about 60° C., and the pressure in the reaction vessel ranges from about 0 psig to about 150 psig.

In another aspect of the invention, the inventive methods provide for the preparation of BSC by the introduction of a silver metal-containing material into a solution of silver, the solution comprising silver, an amine, carbonic acid, and water, wherein the solution comprises a molar ratio of ammonia to silver ranging from about 1:1 to about 3:1, the pH of the solution in the reaction vessel ranges from about 6.5 to about 8.0, the temperature of the solution in the reaction vessel ranges from about 25° C. to about 60° C., and the pressure in the reaction vessel ranges from about 0 psig to about 150 psig.

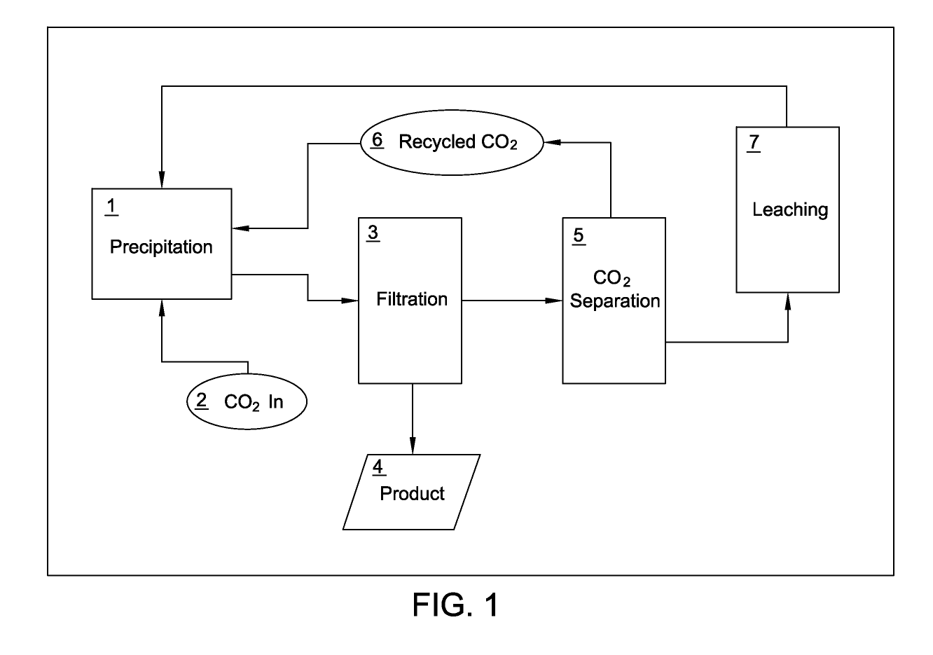

As mentioned previously, an aspect of the inventive methods desirably provides a means for the continuous preparation of BMC. FIG. 1 is a schematic diagram which provides an exemplary operational flow of a method of providing BMC in accordance with this aspect of the invention. Referring to this figure, the method includes processing stages that may be referred to as precipitation 1, filtration 3, CO₂ separation 5, and leaching 7. In the precipitation process, BMC is formed and precipitated from an aqueous solution comprising metal, ammonia, and carbonic acid (provided via the introduction of CO₂ 2, as described herein), as described in more detail herein. After BMC formation is completed, the solution may be filtered 3 to recover the BMC 4.

The filtration process contemplated by the invention may be performed by any suitable means, but is desirably performed under pressure (e.g., between about 1 psig and about 1500 psig) to prevent desorption of CO₂, the latter potentially causing solids to re-dissolve in the solvent solution. Further, filtration under pressure (above ambient) may prevent the solids from agglomerating at the bottom of the filter.

After filtration is completed, the metal-depleted solvent desirably may be degassed to remove excess CO₂ by boiling for a designated time in a vessel equipped with a condenser (to collect the distillate). Alternatively, or in addition, CO₂ may be removed by air stripping or pressure reduction. The CO₂ removed by degassing may be reused by recycling 6 it back to the precipitation vessel 1. The metal-depleted solvent may then be used in a leaching/oxidation process 7 to obtain a replenished metal solution, which solution then may be recycled and utilized in the method described herein (to provide BMC). As this method provides for continuous processing in a closed loop, waste production is minimized and lower energy consumption is achieved.

The exemplary continuous processing illustrated in FIG. 1 is provided as one possible embodiment of the inventive method, and may be modified as desired. For example, the replenished metal solution may be diluted with water prior to its use in the method in order to restore an appropriate solution concentration. Also, after BMC is formed, and prior to filtration, the resultant slurry may be subjected to a thickening process.

The inventive method also contemplates preparing BMC by contacting metal with an aqueous solution comprising an amine, carbonic acid (which may be present as a carbonate, as described herein), and oxygen under conditions where the metal is converted into BMC; and recovering the BMC.

The invention further contemplates a method of forming BMC comprising the steps of providing metal hydroxide in an aqueous solution comprising an amine and a sufficient amount of carbonic acid. Those skilled in the art will appreciate that metal hydroxide may be formed when the solution has a high concentration of hydroxide ions relative to carbonate ions, and that the metal hydroxide is disassociated in the presence of water, providing zinc ions in the aqueous solution.

It is also within normal reason to expect that the carbonate anion could be replaced with other anions, including nitrates, sulfates, and phosphates.

The following examples further illustrate the invention but, of course, should not be construed as in any way limiting its scope.

### Example 1

This example demonstrates production of BZC by reducing the pH of a solution containing zinc, ammonia and CO₂.

1.5 L of an aqueous solution containing CO₂, 76 g/L NH₃, 91 g/L zinc oxide, and at a pH of 10.5, were added to a 2 L pressure reactor. The reaction was started at room temperature. CO₂ gas was added to the solution until a pressure of 100 psi was obtained. The CO₂ was bubbled into the solution at a rate of 0.1 LPM, with constant mixing. At 0.75 hours, the pH was 8.7, the temperature had risen to 36° C. and the pressure had dropped to 70 psi. After 1.25 hours, the reaction was stopped, and filtered; 140 g of white solids were collected by filtration. The remaining solution had a pH of 8.7, a temperature of 34° C., and contained CO₂ and 65 g/L NH₃. The collected solids constituted 50.3% zinc determined by ICP.

This example illustrates the preparation of BZC from a zinc solution by lowering the pH, and without additional energy input (e.g., the solution was not heated after introduction into the reaction flask).

### Example 2

This example demonstrates production of basic nickel carbonate (BNC) at atmospheric pressure by reducing the pH of a solution containing nickel, ammonia and CO₂.

44 g of nickel metal was added to 0.5 L of an aqueous solution containing 153 g/L NH₃ and 102 g/L CO₂. Air was sparged into the solution for 4 hours. After 2 hours, nickel leaching was sped up by heating the solution to 60° C. for 2 hours. The solution then was allowed to mix overnight. CO₂ was bubbled into the 0.5 L solution at a rate of 0.9 LPM at 28° C. At 0.5 hours, green solids were seen. CO₂ addition was continued for 1 hour more and then the solution was filtered. 10 g of green solids were recovered. EDS analysis showed the presence of nickel, carbon and oxygen only.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A continuous method of preparing basic metal carbonates selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising:
(a) providing an aqueous solution of ionized metal, the aqueous solution comprising an ionized metal, an amine, carbonic acid, and water in a reaction vessel;
(b) adjusting the pH of the solution until basic metal carbonate is formed;
(c) recovering the basic metal carbonate from the aqueous solution by subjecting the aqueous solution to filtration;
(d) transferring the aqueous solution which remains after the recovery of basic metal carbonate in step (c) into a second vessel;
(e) removing carbon dioxide from the aqueous solution which remains after the recovery of basic metal carbonate in step (c);
(f) introducing a metal-containing material into the aqueous solution which remains after the removal of carbon dioxide in step (e);
(g) oxidizing the metal-containing material to provide a replenished ionized metal solution; and
(h) introducing the replenished ionized metal solution into the reaction vessel.

2. The continuous method of claim 1, wherein the amine is ammonium hydroxide.

3. The continuous method of claim 1, wherein the temperature of the solution ranges from about 5° C. to about 100° C.

4. The continuous method of claim 1, wherein the temperature of the solution is from about 15° C. to about 80° C.

5. The continuous method of claim 1, wherein reaction vessel is a spray chamber, a stirred tank reactor, a rotating tube reactor, or a pipeline reactor.

6. The continuous method of claim 1, wherein the pH is adjusted by increasing or decreasing the CO₂ concentration.

7. The continuous method according to claim 1, wherein step (b) is carried out at ambient pressure.

8. The continuous method of claim 1, wherein the pressure in the reaction vessel during step (b) ranges from about 0 psig to about 1500 psig.

9. The continuous method of claim 8, wherein the pressure in the reaction vessel during step (b) ranges from about 20 psig to about 500 psig.

10. The continuous method of claim 9, wherein the pressure in the reaction vessel during step (b) ranges from about 80 psig to about 250 psig.

11. The continuous method of claim 1, wherein the metal-containing material is selected from the group consisting of metal-containing plastics, alloys, clads, or compounds.

12. The continuous method of claim 1, wherein the metal is zinc.

13. The continuous method according to claim 12, wherein the ionized metal is zinc, and wherein during step (b) the molar ratio of ammonia to ionized metal in the reaction vessel ranges from about 3:1 to about 8:1, the pH of the solution in the reaction vessel ranges from about 7 to about 10, the temperature of the solution in the reaction vessel ranges from about 5° C. to about 80° C., and the pressure in the reaction vessel ranges from about 0 psig to about 1500 psig.

14. The continuous method according to claim 13, wherein during step (b) the molar ratio of ammonia to ionized metal in the reaction vessel ranges from about 4:1 to about 7:1, the pH of the solution in the reaction vessel ranges from about 7 to about 9, the temperature of the solution in the reaction vessel ranges from about 20° C. to about 60° C., and the pressure in the reaction vessel ranges from about 20 psig to about 500 psig.

15. The continuous method according to claim 14, wherein during step (b) the molar ratio of ammonia to ionized metal in the reaction vessel ranges from about 5:1 to about 7:1, the pH of the solution in the reaction vessel ranges from about 7.5 to about 9, the temperature of the solution in the reaction vessel ranges from about 25° C. to about 40° C., and the pressure in the reaction vessel ranges from about 80 psig to about 250 psig.

16. The continuous method according to claim 1, wherein the ionized metal is nickel, and wherein during step (b) the molar ratio of ammonia to ionized metal in the reaction vessel ranges from about 5:1 to about 7:1, the pH of the solution in the reaction vessel ranges from about 6.5 to about 8.0, the temperature of the solution in the reaction vessel ranges from about 25° C. to about 60° C., and the pressure in the reaction vessel ranges from about 0 psig to about 150 psig.

17. The continuous method according to claim 1, wherein the ionized metal is silver, and wherein during step (b) the molar ratio of ammonia to ionized metal in the reaction vessel ranges from about 1:1 to about 3:1, the pH of the solution in the reaction vessel ranges from about 6.5 to about 8.0, the temperature of the solution in the reaction vessel ranges from about 25° C. to about 60° C., and the pressure in the reaction vessel ranges from about 0 psig to about 150 psig.

18. The method according to claim 1, further comprising the step of introducing carbon dioxide removed in step (e) into the reaction vessel.

19. The method according to claim 1, wherein transfer step (d) occurs prior to the removal of carbon dioxide step (e).

20. A method of preparing BMC selected from the group consisting of zinc carbonate, nickel carbonate, silver carbonate, cobalt carbonate, tin carbonate, lead carbonate, manganese carbonate, lithium carbonate, sodium carbonate, and potassium carbonate from metals comprising: contacting the metal with an aqueous solution comprising an amine, carbonic acid, and oxygen under conditions where the metal is converted into basic metal carbonate; and recovering the basic metal carbonate, wherein the metal is selected from the group consisting of zinc, nickel, silver, cobalt, tin, lead, manganese, lithium, sodium, and potassium.

21. A method of forming basic zinc carbonate comprising: contacting zinc with an aqueous solution comprising an amine, carbonic acid, and oxygen under conditions where the zinc is converted into basic zinc carbonate; and recovering the basic zinc carbonate.

22. A method of forming basic zinc carbonate comprising: contacting zinc with an aqueous solution comprising an amine, carbonic acid, and oxygen under conditions where the zinc is converted into basic zinc carbonate; and recovering the basic zinc carbonate, wherein the aqueous solution comprises a molar ratio of amine to zinc from about 3:1 to about 8:1, the pH of the solution ranges from about 7 to about 10, the temperature of the solution in ranges from about 5° C. to about 80° C., and the pressure ranges from about 0 psig to about 1500 psig.

23. A method of forming basic zinc carbonate comprising: contacting zinc with an aqueous solution comprising an amine, carbonic acid, and oxygen under conditions where the zinc is converted into basic zinc carbonate; and recovering the basic zinc carbonate, wherein the aqueous solution comprises a molar ratio of amine to zinc from about 4:1 to about 7:1, the pH of the solution in the reaction vessel ranges from about 7 to about 9, the temperature of the solution in the reaction vessel ranges from about 20° C. to about 60° C., and the pressure in the reaction vessel ranges from about 20 psig to about 500 psig.

24. A method of forming basic zinc carbonate comprising: contacting zinc with an aqueous solution comprising an amine, carbonic acid, and oxygen under conditions where the zinc is converted into basic zinc carbonate; and recovering the basic zinc carbonate, wherein the aqueous solution comprises a molar ratio of amine to zinc from about 5:1 to about 7:1, the pH of the solution in the reaction vessel ranges from about 7.5 to about 9, the temperature of the solution in the reaction vessel ranges from about 25° C. to about 40° C., and the pressure in the reaction vessel ranges from about 80 psig to about 250 psig.

25. A method of forming basic nickel carbonate comprising: contacting silver with an aqueous solution comprising an amine, carbonic acid, and oxygen under conditions where the silver is converted into basic silver carbonate; and recovering the basic silver carbonate.

26. A method of forming basic silver carbonate comprising: contacting nickel with an aqueous solution comprising an amine, carbonic acid, and oxygen under conditions where the nickel is converted into basic nickel carbonate; and recovering the basic nickel carbonate.
